(19) United States
(12) Patent Application Publication
(10) Pub. No.: US 2005/0235091 A1
(43) Pub. Date: Oct. 20, 2005

(54) USB hub with built-in storage device

(76) Inventors: Caph Chen, Kuo-Hsiung City (TW); Charles Liao, Taipei (TW); Ping-Chang Liu, Chu-Pei City (TW)

Correspondence Address: SUPREME PATENT SERVICES, POST OFFICE BOX 2339, SARATOGA, CA, 95070, US

(21) Appl. No.: 10/829,111

(22) Filed: Apr. 20, 2004

(51) Int. Cl. G06F 13/36

(52) U.S. Cl. 710/313

(57) ABSTRACT

A USB (Universal Serial Bus) hub with built-in storage device is comprised of an upstream interface port to be operated under the USB (universal serial bus) transmission control protocol for serving as a data-switching communication port of relevant devices; a hub device, further comprising a hub control unit, a packet-switching unit, a router, a built-in storage device, and a repeater; and a downstream interface port to be operated also under USB transmission control protocol, being provided with a plurality of interface ports to serve as a data-switching communication port of relevant devices. Therefore, the USB hub of the present invention can serve as an interface for switching connection between USB interfaces with different transmission speeds, such as USB1.1 and USB2.0, for data transmission.

### BACKGROUND OF THE INVENTION

1. Field of the Invention

The present invention relates to a USB hub with built-in storage device, and more specifically, it relates to a USB hub with built-in storage device, in which different data transmission speeds are compatible downwardly with the USB interface.

2. The Prior Arts

The USB (Universal Serial Bus) transmission control protocol is generally considered a cheap yet excellent standard interface to substitute for the conventional interface of serial or parallel transmission port. The USB interface is classified so far in a USB1.1 interface for dealing with full/low speed data stream and a USB2.0 interface for high-speed data stream. The hub architecture is adopted for the USB interface. That is a tree structure, in which every hub is connectable with another, is established. Following to the rapid expansion of computer industry and personal portable devices, USB is undoubtedly a standard interface applied in various computer peripherals, such as mouse, keyboard, writing panel, joystick, digital camera, digital TV receiver, printer, storage device, scanner, microphone, and the likes.

### SUMMARY OF THE INVENTION

Since a conventional USB hub usually does not comprise two convertible USB interfaces, namely, USB2.0 and USB1.1 interface, with different speeds of data stream, in which the USB1.1 interface is a full/low speed interface widely adopted while the USB2.0 interface is an improved high-speed version pending promotion. The USB interface USB2.0 and USB1.1 are concurrently existed in market so far, unfortunately, they are inconvertible into each other that causes inconvenience in case a plurality of external devices having different speeds of data stream is equipped with USB interface, the USB hub can only provide a low transmission speed of data stream to scarify the high-speed USB interface. In addition, as the conventional USB hub lacks the storage capability to have its practicality limited, therefore, an extra storage device with USB interface, such as a USB floppy disk driver or a USB portable disk driver, is occasionally required whenever data storage of transmission is needed.

In view of the mentioned defects, the primary object of the present invention is to provide a USB hub with built-in storage device, which can convert a USB interface into a different one to dissolve the defects.

For realizing the object, a USB hub with built-in storage device is comprised of: an upstream interface port to be operated under the USB transmission control protocol for serving as a data-switching communication port of relevant devices; a hub device composed of a hub control unit, a packet-switching unit, a router, a built-in storage device, and a repeater; and a downstream interface port to be operated also under USB transmission control protocol, being provided with a plurality of interface ports to serve as a data-switching communication port of relevant devices. The repeater is employed to receive signals and retransmit the same. The hub control unit is a logic control unit employed for detecting and controlling each device and the path of data stream. The packet-switching unit is a device for switching a high-speed data stream to a full/low speed data stream. The router is employed to distribute and transmit a data stream to each device connected with the downstream interface port, or distribute and transmit an upstream data stream from the downstream interface port to the repeater or the packet-switching unit. The built-in storage device is employed to store the downstream data transmitted to the downstream interface port.

According to of above described, the merits of a USB hub with built-in storage device of the present invention may be summarized as the following:

(1) Since the USB hub with built-in storage device of the present invention can convert a high-speed data stream into a full/low speed data stream, it may serve as a conversion interface for USB1.1 and USB2.0 to perform a downward compatible conversion.

When a plurality of USB external devices with different speeds of data stream is connected, the USB hub is capable of providing a low and a high transmission speed for data stream so that all the different USB external devices can achieve their best working efficiencies.

(3) As the USB hub is provided with a built-in storage device, it can serve for a portable storage device.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 shows the element disposition of a USB hub with built-in storage device of the present invention; and

FIG. 2 shows an operation flowchart of the USB hub with built-in storage device of the present invention.

### DETAILED DESCRIPTION OF THE PREFERRED EMBODIMENT

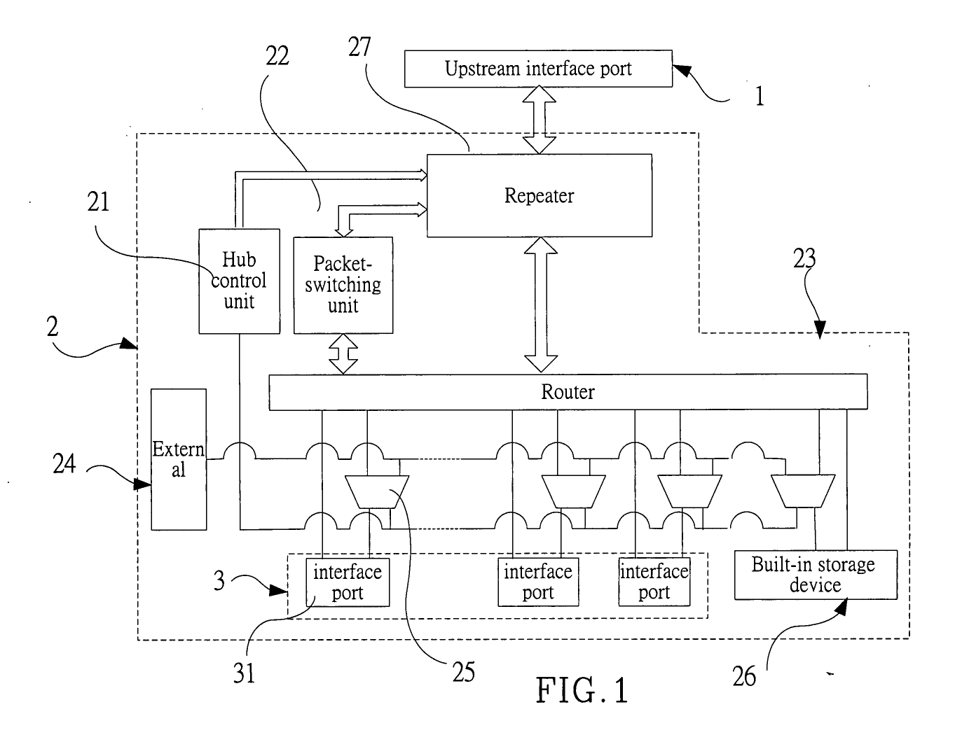

FIG. 1 shows a preferred embodiment of USB hub with built-in storage device of the present invention, composed of an upstream interface port (1), a hub device (2), and a downstream interface port (3). The upstream interface port (1) adopts the USB transmission control protocol to serve as a communication port for data exchange.

The hub device (2) is mainly comprised of a hub control unit (21), a packet-switching unit (22), a router (23), a built-in storage device (26), and a repeater (27), in which the repeater (27) is supposed to receive signals and retransmit the same in integrity to a designated device; the hub control unit (21) is a logic control unit usable for detecting the connecting state of the upstream and the downstream interface port (1)(3) with respective devices and confirming the data transmission speed thereof in order to control data transmission of the repeater (27) to the router (23) or the packet-switching unit (22); the packet-switching unit (22) is a data stream speed converter, capable of converting a high speed data stream into a full speed or low speed data stream; the router (23), under control of the hub control unit (21), is expected to distribute and transmit a data stream to respective devices connected with the downstream interface port (3), or distribute and transmit a data stream provided upstream by the downstream interface port (3) to the repeater (27) or the packet-switching unit (22); and, the built-in storage device (26) is a device for storing downstream data transmitted to the downstream interface port (3), having a memory controller for converting upstream data of the downstream interface port (3) through the USB protocol to make storage of data in memory cells of the built-in storage device (26) possible, without needing a USB interface. Moreover, the USB transmission control protocol adopted downstream interface port (3) is provided with a plurality of interface ports (31) to serve as communication ports for switching data of pertinent devices.

The mentioned hub device (2) also has an external power supply unit (24), and every interface port (31) of the downstream interface port (3) has an on/off switch of power supply (25). The hub control unit (21) functions to manage and detect the load of a device connected with each interface port (31) of the downstream interface port (3) and control the on/off switch of power supply (25). In the event of a device connected with an interface port (31) corresponding to an arbitrary on/off switch of power supply (25) is found overloaded according to the capacity of an internal power supply unit of the hub device (2), the hub control unit (21) is supposed to switch the on/off switch of power supply (25) of the specified interface port (31) to the external power supply unit (24), or, switch the on/off switch of power supply (25) back to the internal power supply unit if the load is bearable, or the hub control unit (21) is to urge the on/off switch of power supply (25) to disable the external power supply unit (24) in the case the load is far over the allowed the consumption limit of the external power supply unit (24).

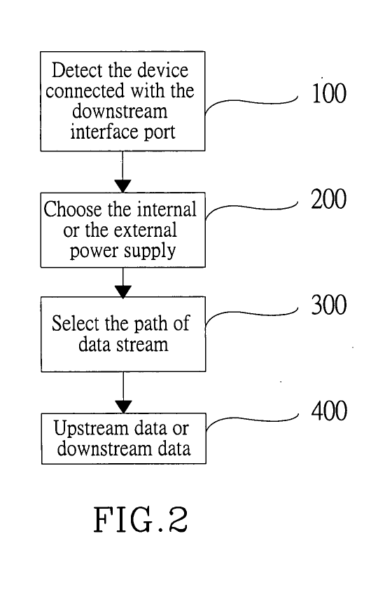

As illustrated in FIG. 2, an operation flowchart of a preferred embodiment of the USB hub with built-in storage device of the present invention includes: a step 100 for the hub control unit (21) to detect the electrical power source specifications of an external device connected with every interface port (31) in the downstream interface port (3), and the transmission speed of data stream; a step 200 for the hub control unit (21) to control the on/off switch of power supply (25) corresponding to an interface port (31) connected with the external device to enable the external device to work normally according to the detected power specifications thereof; a step 300 for the hub control unit (21) to control the repeater (27) so that the path of a data stream will flow directly through the repeater (27) in a high transmission speed, or through the packet-switching unit (22) in a full or low transmission speed according to the detected transmission speed of data stream; and finally, after confirmation of the operation mode of the hub device (2), a step 400 for the data transmitted from the upstream interface port (1) to the hub device (2) to go downstream to the device connected with each interface port (31) under control of the hub control unit (21) via the repeater (27) or the packet-switching unit (22) and through the router (23), or vice versa, for the data of the device connected with each interface port (31) to be transmitted upstream to the upstream interface port (1) through the same data stream path.

Hence, in an embodiment of USB hub with built-in storage device of the present invention as described above, through the hub control unit (21) and based on the power source specifications and speed of data stream of the built-in storage device (26), the on/off switch of power supply (25) corresponding to the interface port (31) connected with the built-in storage device (26) is controlled to switch the connection either with the internal or with the external power source (24), and meanwhile, the path of data stream is also controlled either through the repeater (27) with a high transmission speed of data stream, or through the packet switching unit (22) with a full or low transmission speed of data stream, so that upstream data can be transmitted upstream to the upstream interface port (1) or downstream data can be transmitted to the built-in storage device (26) for storage.

In accordance with foregoing USB hub having built-in storage device of the present invention, If a USB2.0 interface is adopted for a device connected with the upstream interface port (1) and also for an external device connected with the interface port (31) of the downstream interface port (3), the hub control unit (21) is supposed to control the repeater (27) to downstream transmit data directly to the external device connected with the interface port (31), or through the same path of data stream to upstream transmit data to the device connected with the upstream interface port (1). In case a USB1.1 interface is substituted for USB2.0 interface in connection with the mentioned external device of the interface port (31) of the downstream interface port (3), then, the hub control unit (21) would control the packet-switching unit (22) this time to decelerate the downstream data transmission speed of the USB2.0 to a speed suitable for USB1.1 interface to thereby downstream transmit data to the external device, or upstream transmit data through the same path of data stream with the transmission speed of USB1.1 interface to the device connected with the upstream interface port (1). Therefore, different transmission speeds are compatible downwardly with the data transmission interface of the hub device (2).

Though USB2.0 interface and USB1.1 interface represent a high-speed data stream or a full/low speed data stream in this specification, the data transmission speed may be defined differently following to the progressing steps of the USB interface technology, however, the USB hub with built-in storage device of the present invention is proposed here to provide at least two data transmission speeds compatible with USB interface for an external device to select and transmit data upstream or downstream. Therefore, it is understood that a high-speed data stream just means a data transmission speed higher than that of a full/low speed data stream, it is not limited to mean the USB2.0 interface and USB1.1 interface only.

In the above described, at least one preferred embodiment has been described in detail with reference to the drawings annexed, and it is apparent that numerous changes or modifications may be made without departing from the true spirit and scope thereof, as set forth in the claims below.

1. A USB hub, comprising:
an upstream interface port to be operated under the USB transmission control protocol for serving as a data-switching communication port of relevant devices;
a hub device comprised of a hub control unit, a packet-switching unit, a router, and a repeater; in which the repeater is employed to receive signals and retransmit the same to a designated device; the hub control unit is a logic control unit for detecting the connection state of devices to be connected with the upstream and a downstream interface port, and ascertain the data transmission speed thereof for controlling the repeater to transmit data to the router or the packet-switching unit; the packet-switching unit is a device for switching a high-speed data stream to a full/low speed data stream; the router is employed to distribute and transmit a data stream to each device connected with the downstream interface port, or distribute and transmit an upstream data stream from the downstream interface port to the repeater or the packet-switching unit; and
a downstream interface port to be operated also under USB transmission control protocol, being provided with a plurality of interface ports to serve as a data-switching communication port of relevant devices.

2. The USB hub according to claim 1, wherein the hub device is provided with an external power supply unit; each interface port of the downstream interface port possesses an on/off switch of power supply; and the hub control unit is assigned to manage the device connected with each interface port of the downstream interface port, detect the electrical load thereof, and control the on/off switch of power supply to either connect with an internal power source or connect with the external power supply unit.

3. A USB hub with built-in storage device, comprising:
an upstream interface port to be operated under the USB transmission control protocol for serving as a data-switching communication port of relevant devices;
a hub device comprised of a hub control unit, a packet-switching unit, a router, a built-in storage device, and a repeater, in which the repeater is employed to receive signals and retransmit the same to a designated device; the hub control unit is a logic control unit for detecting the connection state of devices to be connected with the upstream and a downstream interface port, and ascertain the data transmission speed thereof for controlling the repeater to transmit data to the router or the packet-switching unit; the packet-switching unit is a device for switching a high-speed data stream to a full/low speed data stream; the router is employed to distribute and transmit a data stream to each device connected with the downstream interface port, or distribute and transmit an upstream data stream from the downstream interface port to the repeater or the packet-switching unit; the built-in storage device is employed to memorize downstream data transmitted to the downstream interface port; and
a downstream interface port to be operated also under USB transmission control protocol, being provided with a plurality of interface ports to serve as a data-switching communication port of relevant devices.

4. The USB hub with built-in storage device according to claim 3, wherein the hub device is provided with an external power supply unit; each interface port of the downstream interface port possesses an on/off switch of power supply; and the hub control unit is assigned to manage the device connected with each interface port of the downstream interface port, detect the electrical load thereof, and control the on/off switch of power supply to either connect with an internal power source or connect with the external power supply unit.
